(19) United States
(12) Patent Application Publication
(10) Pub. No.: US 2026/0326356 A1
(43) Pub. Date: Oct. 22, 2026

(54) METHOD FOR PRODUCING A BARRIER LAYER LAMINATE, BARRIER LAYER LAMINATE AND CONTAINER MADE FROM THE BARRIER LAYER LAMINATE

(71) Applicant: Greif International Holding B.V., Amstelveen (NL)

(72) Inventor: Reginaldo Cintra IURKIV, São Paulo (BR)

(21) Appl. No.: 19/106,942

(22) PCT Filed: Aug. 31, 2023
(86) PCT No.: PCT/EP2023/073886

§ 371 Date: Feb. 26, 2025

(30) Foreign Application Priority Data
Sep. 1, 2022 (DE) DE102022122136.9

(51) Int. Cl. B29C 48/00; B29B 17/00; B29B 17/04; B29C 48/09; B29C 48/21; B29K 23/00; B29K 77/00; B29K 105/26; B29L 9/00

(52) U.S. Cl. CPC B29C 48/022; B29B 17/0042; B29B 17/0412; B29C 48/09; B29C 48/21; B29K 2023/065; B29K 2023/086; B29K 2077/00; B29K 2105/26; B29K 2995/0063; B29L 2009/00

(57) ABSTRACT

A method for producing a barrier layer laminate, in particular for producing containers includes providing an extrudable barrier layer material; providing a polyolefin; providing particles, in particular flakes or pellets, of layered plastic material obtained by a comminution of an existing or recycled extrudable layer laminate with barrier layer; mixing a portion of the polyolefin with the particles to produce a recycling plastic mixture; feeding the barrier layer material, the polyolefin and the recycling plastic mixture into respective extruders; and carrying out a coextrusion of barrier layer material, polyolefin and recycling plastic mixture to form a barrier layer laminate having the following layer sequence: a first outermost layer, namely a barrier outer layer; an embedded layer, namely a layer of recycling plastic mixture; a second outermost layer arranged opposite the first outermost layer, namely a polyolefin outer layer and a barrier layer laminate produced by such a method and a container made of a barrier layer material, as well as methods for it.

The invention relates to a method for producing a barrier layer laminate according to the preamble of claim 1, a barrier layer laminate according to the preamble of claim 8 and a container with/made of such a barrier layer laminate according to the preamble of claim 9, as well as a method for producing a container with/made of such a recycled barrier layer laminate.

Barrier layer laminates have been known from the prior art for some time. The term barrier layer laminates refers to laminates that have a barrier layer that is impermeable to gases. According to the prior art, the structure of previous barrier layer laminates is based on the fact that such laminates have one or more barrier layers that are integrated into the laminate structure, or the layer structure, of the rest of the base laminate.

A disadvantage of these barrier-layer laminates known to date is that a bond between the one or several barrier layer(s) and the layers arranged adjacent to the barrier layer must, on the one hand, be very strong and stable in order to avoid delamination of the layers, but this, on the other hand, means that the barrier layers and the other layers of the laminate are, in a disadvantageous way, practically no longer separable from one another. The latter has an extremely adverse effect in particular upon reuse or recycling of products produced with such a barrier layer laminate, such as packaging or containers, or rather their materials, and in most cases prevents effective recycling. This is essentially because the structure-imparting base materials, such as polyethylene or polypropylene, from which such barrier layer laminates are made, are generally non-polar, while the barrier layer materials themselves, such as polyamide or ethylene vinyl alcohol copolymer, have polar groups.

The object of the invention is to provide a method, as well as a barrier layer laminate and a container made with such a barrier layer laminate, with which the above-mentioned problems are avoided and a reusability and recyclability of products comprising such barrier layer laminates is improved compared to the prior art.

This object is solved by a method according to claim 1, by a barrier layer laminate according to claim 8 and by a container made from such a barrier layer laminate according to claim 9, as well as further by a method for producing a container with/from such a recycled barrier layer laminate according to claims 13 and 14.

In particular, the object of the invention is solved by a method for producing a barrier layer laminate, in particular for producing containers, in which the following steps are carried out:
providing an extrudable barrier layer material;
providing a polyolefin;
providing particles, in particular flakes or pellets, of layered plastic material which is obtained by a comminution of existing or recycled extrudable layer laminate with barrier layer;
mixing a portion of the polyolefin with the particles to produce a recycling plastic mixture;
feeding the barrier layer material, the polyolefin and the recycling plastic mixture into respective extruders; and
carrying out a coextrusion of barrier layer material, polyolefin and recycling plastic mixture to form a barrier layer laminate having the following layer sequence:
1) a first outermost layer, namely a barrier outer layer;
2) an embedded layer, namely a layer of recycling plastic mixture;
3) a second outermost layer arranged opposite the first outermost layer, namely a polyolefin outer layer.

An essential point of the invention lies in the fact that in the method for producing a novel barrier layer laminate according to the invention, particles are used that are obtained by a comminution of existing or already recycled layer laminate with a barrier layer, such as, for example, a barrier layer laminate. An important point of the invention is that these particles, such as flakes or pellets, consist of a layered plastic material which itself already contained or contains a barrier layer.

By intensively mixing the particles with a structure-imparting base material, such as polyethylene or polypropylene, which is used to produce the desired products, which may be plastic containers with a barrier layer, for example, and subsequent feeding of this mixture into an extruder, which is part of a coextrusion device for producing the desired barrier layer laminate, the different materials, i.e. the structure-imparting base materials and the barrier layer material(s) are so thoroughly fused and bonded to each other that on the one hand the structure-imparting base material itself is already given a certain barrier layer effect and, on the other hand, a polar/non-polar phase separation is effectively avoided.

Another important point of the invention is that the recycling plastic mixture obtained by intimately mixing the particles of existing barrier layer plastic material with original structure-imparting base polymer material is extruded between a first outermost layer made of a barrier layer material and a second outermost layer arranged opposite the first outermost layer, which is a polyolefin outer layer of the structure-imparting base material of the base material.

The recycling plastic layer thus fulfils several extremely advantageous purposes according to the invention. Thus, the recycling plastic layer, which is extruded between the first outermost barrier outer layer and the second outer layer of polyolefin material, which is located opposite the first outer layer, acts as a kind of compatibilising agent between the polar first outer layer and the polar second outer layer, wherein the inside recycling plastic layer simultaneously enhances the barrier layer effect of the first outer barrier outer layer due to its barrier layer material components.

Another extremely advantageous effect of the method according to the invention, as well as of the barrier layer laminate produced thereby, is that both the method according to the invention as well as the barrier layer laminate produced thereby, and in this context, of course, the containers produced from this barrier layer laminate, enable a simple, very cost-effective and, in addition, extremely effective reuse of barrier layer laminates and in particular the barrier layer laminate produced according to the invention.

Another advantage of the method according to the invention and of the products produced with it is that the recycling plastic layer is embedded between two pure layer materials, namely the barrier outer layer and the polyolefin outer layer, so that the barrier layer laminate produced according to the invention has precisely defined properties on each outer side, namely those of the used barrier outer layer material on the one hand, and those of the used polyolefin outer layer material on the other hand, and any inhomogeneities or impurities that may be present in the recycling plastic layer are irrelevant to the produced product and do not take effect.

According to an embodiment of the invention, an adhesion-promoting layer is extruded between the barrier outer layer and the layer of recycling plastic mixture in the course of the coextrusion in order to produce a 4-layer barrier laminate, i.e. a barrier laminate with four layers.

According to this embodiment, the adhesion-promoting layer itself is a layer of the 4-layer barrier laminate, which is extruded from a separate extruder die between the barrier outer layer and the layer of recycling plastic mixture. This adhesion-promoting layer serves in an advantageous manner to improve adhesion between the barrier outer layer and the layer of recycling plastic mixture.

According to a further embodiment of the invention, a further layer of polyolefin, namely a polyolefin intermediate layer, is also extruded between the adhesion-promoting layer and the layer of recycling plastic mixture in the course of the coextrusion, in order to produce a 5-layer barrier laminate, i.e. a barrier layer laminate with five layers.

According to the invention, this polyolefin intermediate layer serves to structurally reinforce the barrier layer laminate to be produced.

According to the invention, the recycling plastic mixture has a particle content in the range from 30 wt. % to 95 wt. %, preferably in the range from 45 wt. % to 80 wt. % and particularly preferably in the range from 55 wt. % to 75 wt. %.

Since these particles, which are in particular in the form of flakes or pellets, are themselves already recycled plastic material which comprises barrier layer components such as, for example, ethylene vinyl alcohol copolymer and/or polyamide, a particle content in the range from 30 wt. % to 95 wt. %, preferably in the range from 45 wt. % to 80 wt. % and particularly in the range from 55 wt. % to 75 wt. %, reflects the very high recycling capacity of the method according to the invention, since the method according to the invention is suitable for producing a barrier layer material which consists of more than half up to three quarters of recycled material. By the method according to the invention it is thus possible to produce a barrier layer material as good as new, which consists mainly of recycled components.

According to a further embodiment of the invention, the polyolefin outer layer may comprise an additive and/or a colouring agent in the following proportions by weight of the total weight:

| | 4-layer barrier laminate | 5-layer barrier laminate |
|---|---|---|
| additive | 11.2 ± 5 wt. %, preferably ± | |
| | 4 wt. % and particularly | |
| | preferably # 3 wt. % | |
| colourant | 10.0 ± 0.5 wt. %, | 7.4 ± 0.5 wt. %, |
| | preferably = 0.4 wt. % | preferably = 0.4 wt. % |
| | and particularly | and particularly |
| | preferably ± 0.3 wt. % | preferably ± 0.3 wt. % |

According to a further embodiment of the invention, the colourant content of the polyolefin outer layer can also be in a range from 0 to 10 wt. %, preferably in a range from 0.1 to 9 wt. % and particularly preferably in a range from 0.01 to 8 wt. % in both the 4-layer barrier laminate as well as the 5-layer barrier laminate, wherein a weight percentage of 0 wt. % is particularly advantageous for a colourant-free polyolefin outer layer and/or a colourant-free barrier layer laminate. In this context, “colourant-free” is to be understood as a colourant-free polyolefin outer layer or the “natural” colour of the barrier layer laminate, which does not contain any explicitly added colourant, resulting from the layer sequence of the barrier layer laminate and its components.

According to a preferred embodiment of the invention, a polyethylene modified with maleic anhydride is used as an additive, wherein the use of such an additive promotes a mixing and homogenisation of the non-polar base polymer, i.e. polyethylene and/or polypropylene, with the polar barrier layer material, i.e. polyamide and/or ethylene vinyl alcohol copolymer so that, for example, when using HDPE as the base polymer and polyamide or ethylene vinyl alcohol copolymer as the barrier layer material, after an initial mechanical mixing and a subsequent heating in the extruder, a unique material mixture is formed which is homogeneously mixed and shows no phase separation, so that products made from it have similar characteristics, in particular with regard to their physical, mechanical and other properties, as if pure HDPE had been used to produce these products, so that this HDPE barrier layer material mixture can be used as a replacement for and/or as HDPE.

According to a further embodiment of the invention, the polyolefin intermediate layer comprises an additive and/or a colourant in amounts by weight of the total weight in the following range: 8.6±5 wt. %, preferably 6±4 wt. %, and particularly preferably 2.3±2 wt. %.

According to a further embodiment of the invention, the colourant content of the polyolefin intermediate layer can also be in a range from 0 to 9 wt. %, preferably in a range from 0.1 to 6 wt. % and particularly preferably in a range from 0.01 to 2 wt. % in both the 4-layer barrier laminate as well as the 5-layer barrier laminate, wherein a weight percentage of 0 wt. % is particularly advantageous for a colourant-free polyolefin intermediate layer and/or a colourant-free barrier layer laminate. In this context, “free of colourants” is to be understood as a colourant-free polyolefin intermediate layer or the “natural” colour of the barrier layer laminate, which does not contain any colourant that has been explicitly added, which results from the layer sequence of the barrier layer laminate and its components.

Furthermore, the barrier layer laminate consists of layers with the following proportions by weight of the total weight:

| layer | 4-layer barrier laminate | 5-layer barrier laminate |
|---|---|---|
| barrier outer layer | 12 ± 6 wt. %, preferably | 12 ± 6 wt. %, preferably |
| | 10 ± 5.5 wt. % and | 10 ± 5.5 wt. % and |
| | particularly preferably | particularly preferably |
| | 7 ± 5 wt. % | 7 ± 5 wt. % |
| adhesion-promoting | 12 ± 6 wt. %, preferably | 12 ± 6 wt. %, preferably |
| layer | 10 ± 5.5 wt. % and | 10 ± 5.5 wt. % and |
| | particularly preferably | particularly preferably |
| | 7 ± 5 wt. % | 7 ± 5 wt. % |
| polyolefin | — | 50 ± 20 wt. %, preferably |
| intermediate | | 30 ± 15 wt. % and |
| layer | | particularly preferably |
| | | 25 ± 10 wt. % |
| layer of | 69.5 ± 40 wt. %, | 69.5 ± 40 wt. %, |
| recycling plastic | preferably 50 ± 40 wt. % | preferably 50 ± 40 wt. % |
| mixture | and particularly | and particularly |
| | preferably 40 ± 30 wt. % | preferably 40 ± 30 wt. % |
| polyolefin | 40 ± 30 wt. %, preferably | 40 ± 30 wt. %, preferably |
| outer layer | 35 ± 25 wt. % and | 35 ± 25 wt. % and |
| | particularly preferably | particularly preferably |
| | 30 = 20 wt. % | 30 ± 20 wt. % |

According to a further advantageous embodiment of the invention, a polyethylene having a density in the range from 0.94 g/cm3 to 0.97 g/cm³, preferably in the range from 0.95 g/cm3 to 0.97 g/cm3 and particularly preferably in the range from 0.951 g/cm3 to 0.961 g/cm³, and preferably HDPE, is used as the polyolefin.

Furthermore, according to one embodiment of the invention, polyamide and/or ethylene vinyl alcohol copolymer (EVOH) is preferably used as the barrier layer material.

Furthermore, according to a preferred embodiment of the invention, a polyethylene modified with maleic anhydride and having a density greater than 0.800 g/cm³, preferably having a density in the range from 0.800 g/cm3 to 0.935 g/cm3 is used as additive, as well as optionally a polyethylene modified with maleic anhydride and having a density of greater than 0.800 g/cm³, preferably with a density in the range from 0.800 g/cm3 to 0.935 g/cm³, particularly preferably with a density in the range from 0.921±0.015 g/cm3 is used as an adhesion promoter.

Furthermore, the object of the invention is also solved by a barrier layer laminate, which is produced by a method according to the above explanations.

Furthermore, the object of the invention is also solved by a container, which is produced from a barrier layer material according to the above explanations.

In the context of the method according to the invention, the components of a respective individual layer of the barrier layer material to be produced are each fed into a respective individual extruder, and there transition to molten paste-like state due to heating, friction and the transport in the extruder, so that a homogeneous mass is produced within each extruder, which can be processed into well-distributed and defined layers. The combination of the respective layers takes place in a coextrusion machine, which, depending on whether 4-layer barrier laminates or 5-layer barrier laminates are to be produced, has four or five extruders that lead into a common coextrusion head, at which a preform with connected layers of defined thickness is formed.

To produce a container from such a barrier layer material, the preform from the preceding process is placed in a non-melted state in a steel/aluminium mould cooled with cold water at temperatures between 8 °C and 15 °C in order to form the preform with a predetermined design and to cool it, whereby the formed container changes from a pasty state to a solid state. The shaping is done by blowing compressed air at a pressure in the range from 7 to 10 bar for a certain time into the preform, so that the produced product undergoes the correct shaping and solidification and thus takes on the shape of the mould.

Barrier layer laminates produced by the method according to the invention, as well as products made from them, such as containers, can, after being used, be comminuted and ground into flakes or pellets, which can be completely reused for the production of a new barrier layer laminate by means of the method according to the invention, so that practically no material loss or waste occurs. These flakes or pellets can subsequently be immediately and directly reintroduced into the production method according to the invention or stored for future use, so that again there is no material loss or waste, and the material of the produced barrier layer laminate can be reused in a closed cycle.

An important point in the method according to the invention is that the flakes produced in the previous process have well-defined, separate layers with an additive. The materials must be mixed so that homogenisation and compatibilisation can take place. At the correct respective heating and the correct respective pressure, the additive maleic anhydride (MA) reacts with the non-polar residue in the polyethylene and the polar part in the EVOH and/or polyamide, improving the miscibility and reducing the surface tension, whereby a dispersion of the materials with each other is facilitated and improved and the mixture obtains very similar properties to those of a pure HDPE with dispersed molecules of the amine group, whereby the good recycling properties of the barrier layer laminate according to the invention are achieved.

With the help of an extruder, the material, i.e. the flakes or pellets, is taken up via a hopper so that the repelletisation material, which is ready for the next process, i.e. recycling cycle, can be produced by the extrusion process at the correct temperature, with the correct L/D ratio and the correct compression.

Thus, with the method according to the invention, the object to use the pellets produced in the previous process as starting material for the production of a new barrier layer material or a new packaging, is solved.

Thus, the object of the invention is also solved by a container that was made with a proportion from 45 wt. % to 80 wt. %, preferably from 55 wt. % to 75 wt. % and particularly preferably from 68 wt. % to 72 wt. %, of a recycled and homogenised barrier layer material according to the above explanations or from a recycled and homogenised barrier layer material according to the above explanations, wherein the above mentioned proportion of recycled and homogenised barrier layer material in the container according to the invention is made up with a proportion of a virgin high-density polyethylene, namely virgin HDPE, to 100 wt. %.

With regard to the term “virgin” polyolefin, “virgin” polyethylene or “virgin” HDPE, it should be noted that in the context of this invention, this term is to be understood as pure polyolefin, polyethylene or HDPE that comes directly from the production process and is not mixed or blended with other substances.

A significant advantage of the barrier layer material according to the invention is that this barrier layer material, which was originally produced in a multilayer form, can itself be used as a raw material for the production of new containers, since the non-polar substances present in the multilayer barrier laminate, i.e. essentially polyolefin, in particular HDPE, as well as the polar substances present therein, i.e. in particular the barrier layer materials polyamide and/or EVOH, can be mixed and reorganised due to the presence of a compatibilising agent, namely the additive maleic anhydride used in accordance with the invention, wherein it has been found in accordance with the invention that the barrier layer material according to the above explanations and in the above-stated weight percent ratio, after intensive mixing and homogenisation, for example in an extruder, behaves almost identically to pure polyolefin and can therefore, outstandingly, not only be mixed with pure, i.e. “virgin” polyolefin, but also be, in particular flatly, bonded thereto, without the need for any further functional substances, such as primers or adhesives.

The essential advantage of such a barrier layer material or barrier layer laminate produced in accordance with the invention and then homogenised is therefore that the barrier layer material can be easily homogenised after its first use, for example for a film or a container or another article made from it, and in doing so develops almost identical properties to the polyolefin on which the barrier layer material is based. In this regard, it has been found that HDPE is particularly suitable as a base olefin.

An important point in the further use of the barrier layer laminate produced according to the invention and then homogenised for other containers, such as bottles or canisters, is further that the recycling material or material from the barrier layer laminate homogenised in this way is mixed with a “virgin” polyolefin, whereby an important point is that the base olefin of the recycling material of the barrier layer laminate and the added “virgin” polyolefin are of the same type, such as HDPE.

For a further use of the barrier layer laminate produced according to the invention and then homogenised, this recycled material with a proportion of 45 to 80 percent by weight, preferably 55 to 75 percent by weight and particularly preferably with a proportion of 68 to 72 percent by weight, is mixed with a proportion of “virgin” polyolefin, in particular HDPE, wherein the respective proportions of recycled material of barrier layer laminate and “virgin” polyolefin add up to 100%.

Thus, another important point of the invention is that, for the production of containers from the barrier layer laminate produced according to the invention and then homogenised, in addition to admixed “virgin” polyolefin, no further substance, such as an adhesive or a primer or even a barrier layer material, is necessary in order to produce a container from this recycling material according to the invention.

The recycling material according to the invention, which, in addition to the material of the original barrier layer laminate, exclusively comprises the same polyolefin that also represents the base olefin of the barrier layer laminate, is thus a uniform and essentially completely homogeneous extrudable material mixture with essentially the same properties as the pure base olefin. As already mentioned, the base olefin is preferably HDPE according to the invention.

According to the invention, the container is a one-layer container according to one embodiment of the invention, wherein the recycled and homogenised barrier layer material and the “virgin” polyolefin, in particular HDPE, are homogeneously mixed with each other.

Alternatively, the container can also be designed as a two-layer container, wherein the recycled and homogenised barrier layer material and the “virgin” polyolefin, in particular HDPE, are arranged next to each other, flatly adhering to each other.

According to a further embodiment of the invention, the container is a three-layer container, wherein the recycled and homogenised barrier layer material is arranged centrally and flatly adhering to each other between two double-sided “virgin” HDPE layers.

According to the invention, it is thus possible to produce a container that consists of a single homogeneous material that defines the shape and the wall of the container as a single layer.

According to a further embodiment of the invention, the container according to the invention can also be formed in two layers, wherein the recycling material of barrier layer laminate and the “virgin” polyolefin, in particular HDPE, are present adhering flatly over the entire surface to one another in the form of two layers that are discrete in terms of origin, which, due to their essentially identical properties, abut against one another at their respective boundary surfaces and are intimately and inseparably bonded to one another.

According to a further alternative embodiment of the invention, the recycling material of barrier layer laminate can also be surrounded on both sides by the “virgin” polyolefin, in particular HDPE, wherein here also the bond between the two “virgin” polyolefin layers, namely preferably HDPE layers, and the inner layer of recycling material of barrier layer laminate is intimate, flatly over the entire surface and inseparable without damage.

According to the invention, the container is a rigid, preferably self-supporting container, for example a bottle- or canister-like as well as optionally stackable container, which preferably has a capacity in the range from 0.5 litres to 50 litres, particularly preferably in the range from 1 litre to 20 litres. Furthermore, the container according to the invention can also be suitable for holding hazardous goods, such as, for example, for flammable and/or oily liquids, but also for alkalis or acids.

Furthermore, the object according to the invention is also solved by a method for producing a container, which is characterised by the following steps:
providing a barrier layer laminate according to the above explanations or a, preferably cleaned, container that has been produced from the barrier layer laminate;
comminuting the barrier layer laminate or the container in order to produce particles, in particular flakes or pellets;
providing a polyolefin, such as preferably a polyethylene having a density in the range from 0.94 g/cm3 to 0.97 g/cm³, more preferably in the range from 0.95 g/cm3 to 0.97 g/cm3 and particularly preferably in the range from 0.951 g/cm3 to 0.961 g/cm³, and particularly preferably a high-density polyethylene, namely HDPE;
   feeding the comminuted barrier layer laminate, in particular the particles, in particular flakes or pellets, and the polyolefin, in particular HDPE, into a common extruder in order to homogeneously mix the particles, in particular flakes or pellets, of the barrier layer laminate and the, preferably flake- and/or pellet-shaped, polyolefin, in particular HDPE, and to extrude them together through a single extruder nozzle into a preform of the container, in order to produce a one-layer container;
or
   feeding the comminuted barrier layer laminate, in particular the particles, in particular flakes or pellets, and the polyolefin, in particular HDPE, into two extruders, in particular with extruder nozzles arranged concentrically to one another, in order to extrude the particles, in particular flakes or pellets, of the barrier layer laminate and the, preferably flake- and/or pellet-shaped polyolefin, in particular HDPE, parallel to one another through two extruder nozzles into a preform of the container, in order to produce a two-layer container;
or
   feeding the comminuted barrier layer laminate, in particular the particles, in particular flakes or pellets, and the polyolefin, in particular HDPE, into three extruders, in particular with extruder nozzles arranged concentrically to one another, in order to extrude the particles, in particular flakes or pellets, of the barrier layer laminate and the, preferably flake- and/or pellet-shaped polyolefin, in particular HDPE, parallel to one another through three extruder nozzles into a preform of the container, in order to produce a three-layer container, wherein the polyolefin, in particular HDPE, is fed into the two respective outer extruders;
inflating the respective preform produced.

An important point of this method according to the invention is that a barrier layer laminate and/or a container or other product made therefrom is first provided, which is then comminuted to particles, such as flakes or pellets. Furthermore, an important point of the method according to the invention is that a “virgin” polyolefin, which preferably corresponds to the base polyolefin of the barrier layer laminate, is provided.

Depending on whether a single-, two- or three-layer container is to be produced, the starting material, namely the shredded barrier layer laminate and the ‘virgin’ polyolefin, is now fed into a common extruder or, depending on the number of layers desired, two or three separate extruders, which are suitable for producing a preform of the desired container in a conventional manner known from the prior art.

In the case of a desired two-layer container, the shredded barrier layer laminate is fed into one extruder, while the “virgin” polyolefin is fed into the other extruder.

In the case of a desired three-layer container, the shredded barrier layer laminate is also fed into one extruder, while the “virgin” polyolefin is divided between two extruders.

The extruder nozzles are preferably arranged concentrically to one another, whereby it is to be ensured that the extruder nozzles, or rather the contents to be extruded with them, are arranged in the desired order, so that in the case of a two-layer container, the “virgin” polyolefin, in particular HDPE, is arranged inside or outside the container to be produced, as desired, and that in the case of a three three-layer container, the middle layer consists of the homogenised barrier layer laminate material.

Due to the common extrusion, i.e. the coextrusion of the respective two or three layers that are to form the container according to the invention, the respective layers come into contact with each other immediately after leaving the extruder nozzles while still hot, which leads to an optimal and firm bond between the layers. This optimal bond of the layers to one another is also favoured by the fact that the material properties of the homogenised barrier layer laminate material, which is preferably based on HDPE, and the “virgin” polyolefin, in particular HDPE, are almost, i.e. essentially, identical and can therefore be intimately bonded to one another.

Furthermore, the object of the invention is also solved by a method for producing a one-layer container, wherein the following steps are carried out:
providing material from at least one container made of homogenised barrier layer laminate material and “virgin” polyolefin, in particular HDPE;
comminuting the material from at least one container made of homogenised barrier layer laminate material and “virgin” polyolefin, in particular HDPE, to produce particles, in particular flakes or pellets, of the material;
feeding the comminuted material into an extruder to homogenously mix the particles, in particular flakes or pellets, of the comminuted material and to commonly extrude through an extruder nozzle into a preform of the container to produce a one-layer container;
inflating the preform produced.

An important and very advantageous point of the method according to the invention for producing a container from recycling material is that the material that was necessary to produce the “recycling container” made from recycling material can practically be used over and over again in a closed-loop process to produce a container, as soon as the original barrier layer laminate has once been mixed with “virgin” polyolefin, in particular HDPE. This is therefore practically a closed-loop process.

In this case, the proportion of additive, namely maleic anhydride, in the recycling material to be extruded can optionally be increased to a proportion in the range from 0.9 wt. % to 2.0 wt. % before the extrusion, in order to ensure a consistently good mixability and homogenisability of the material necessary for the production of the desired recycling containers.

For the production of a container according to the invention, the granules obtained from the barrier layer laminate are fed to a blower in a proportion of, for example, 70 wt. % of the total packaging, while in this example the remaining 30 wt. % are “virgin” HDPE. As in the barrier laminate granules amine groups from polyamide chains and/or hydroxyl residues from EVOH are dispersed, it is possible to mix or to homogenise the granules with new HDPE, resulting in a unique blend without phase separation, which has similar properties to HDPE and can thus be used for the production of new packaging with the same physical, mechanical and performance-related properties as a packaging made from new raw material or even PCR-HDPE (Post Consumer Recycled HDPE).

Further embodiments of the invention arise from the dependent claims.

The invention is described in more detail below on the basis of execution examples.

In the following barrier layer laminates according to the invention, which can be used in the form of 4-layer barrier laminates and 5-layer barrier laminates for the production of containers, for example with a capacity of four litres, 10 litres or even 20 litres, but also for all other desired volumes, are described.

According to the invention, in the described execution examples, as
structure-imparting base polymer HDPE (high-density polyethylene) with a density in the range from 0.951 g/cm3 to 0.961 g/cm³,
barrier layer material EVOH (ethylene vinyl alcohol copolymer) with a density of 1.19 g/cm3 or a polyamide with a density in the range from 1.05 g/cm3 to 1.06 g/cm³,
adhesive agent a 0.2% modified LDPE (low-density polyethylene) with a density of 0.921 g/cm³,
additive a 0.9% modified VLDPE (very low-density polyethylene) with a density of 0.875 g/cm³,
   are used. The density of the colourant used is in the range of the above-mentioned substances.

According to the invention, these substances are each fed to the respective extruder assigned to them in each case in accordance with the execution examples mentioned below and extruded at temperatures in the range from 170 °C to 250 °C, preferably 190 °C to 230 °C, by coextrusion to the respective desired barrier layer laminate.

In the course of this coextrusion, three-dimensional preforms can be produced which, after cooling to a temperature in the range from 8 °C to 15 °C, are inflated in a further step in a blow mould enclosing the preforms, with compressed air and a pressure in the range from seven to ten bar, to a respective desired container with a respective desired geometry.

The weight proportions in the tables below are given in grams.

### EXECUTION EXAMPLE 1

4-layer barrier laminate

| | | weight | percentage |
|---|---|---|---|
| extruder | raw material | proportion | proportion |
| extruder 1 | barrier outer layer, | 82.6 | 7.00% |
| | namely polyamide | | |
| extruder 2 | adhesion promoter | 47.2 | 4.00% |
| | layer | | |
| extruder 3 | milled recycling | 821.28 | 69.60% |
| | plastic mixture | | |
| extruder 4 | pure, i.e. virgin | 173.47 | 14.70% |
| | base polymer | | |
| | additive | 31.85 | 2.70% |
| | colourant | 23.6 | 2.00% |
| | | 1180 | 100.00% |

### EXECUTION EXAMPLE 2

4-layer barrier laminate

| | | weight | percentage |
|---|---|---|---|
| extruder | raw material | proportion | proportion |
| extruder 1 | barrier outer layer, | 30.72 | 6.00% |
| | namely polyamide | | |
| extruder 2 | adhesion promoter | 17.92 | 3.50% |
| | layer | | |
| extruder 3 | milled recycling | 358.912 | 70.10% |
| | plastic mixture | | |
| extruder 4 | pure, i.e. virgin | 84.48 | 16.50% |
| | base polymer | | |
| | additive | 9.728 | 1.90% |
| | colourant | 10.24 | 2.00% |
| | | 512 | 100.00% |

### EXECUTION EXAMPLE 3

4-layer barrier laminate

| | | weight | percentage |
|---|---|---|---|
| extruder | raw material | proportion | proportion |
| extruder 1 | barrier outer layer, | 15.6 | 6.00% |
| | namely polyamide | | |
| extruder 2 | adhesion promoter | 9.1 | 3.50% |
| | layer | | |
| extruder 3 | milled recycling | 182.39 | 70.10% |
| | plastic mixture | | |
| extruder 4 | pure, i.e. virgin | 42.8 | 16.50% |
| | base polymer | | |
| | additive | 4.91 | 1.90% |
| | colourant | 5.2 | 2.00% |
| | | 260 | 100.00% |

### EXECUTION EXAMPLE 4

4-layer barrier laminate

| | | weight | percentage |
|---|---|---|---|
| extruder | raw material | proportion | proportion |
| extruder 1 | barrier outer layer, | 8.64 | 8.00% |
| | namely EVOH | | |
| extruder 2 | adhesion promoter | 4.32 | 4.00% |
| | layer | | |
| extruder 3 | milled recycling | 73.47 | 68.00% |
| | plastic mixture | | |
| extruder 4 | pure, i.e. virgin | 16.75 | 15.50% |
| | base polymer | | |
| | additive | 2.66 | 2.50% |
| | colourant | 2.16 | 2.00% |
| | | 108 | 100.00% |

### EXECUTION EXAMPLE 5

5-layer barrier laminate

| | | weight | percentage |
|---|---|---|---|
| extruder | raw material | proportion | proportion |
| extruder 1 | barrier outer layer, | 82.60 | 7.00% |
| | namely polyamide | | |
| extruder 2 | adhesion promoter | 47.2 | 4.00% |
| | layer | | |
| extruder 3 | pure, i.e. virgin | 263.14 | 22.30% |
| | base polymer | | |
| | additive | 31.86 | 2.70% |
| extruder 4 | milled recycling | 436.6 | 37.00% |
| | plastic mixture | | |
| extruder 5 | pure, i.e. virgin | 295 | 25.00% |
| | base polymer | | |
| | colourant | 23.6 | 2.00% |
| | | 1180 | 100.00% |

### EXECUTION EXAMPLE 6

5-layer barrier laminate

| | | weight | percentage |
|---|---|---|---|
| extruder | raw material | proportion | proportion |
| extruder 1 | barrier outer layer, | 33.72 | 6.00% |
| | namely polyamide | | |
| extruder 2 | adhesion promoter | 19.67 | 3.50% |
| | layer | | |
| extruder 3 | pure, i.e. virgin | 129.822 | 23.10% |
| | base polymer | | |
| | additive | 10.678 | 1.90% |
| extruder 4 | milled recycling | 216.37 | 38.50% |
| | plastic mixture | | |
| extruder 5 | pure, i.e. virgin | 140.5 | 25.00% |
| | base polymer | | |
| | colourant | 11.24 | 2.00% |
| | | 562 | 100.00% |

### EXECUTION EXAMPLE 7

5-layer barrier laminate

| | | weight | percentage |
|---|---|---|---|
| extruder | raw material | proportion | proportion |
| extruder 1 | barrier outer layer, | 15.60 | 6.00% |
| | namely polyamide | | |
| extruder 2 | adhesion promoter | 9.1 | 3.50% |
| | layer | | |
| extruder 3 | pure, i.e. virgin | 60.06 | 23.10% |
| | base polymer | | |
| | additive | 4.94 | 1.90% |
| extruder 4 | milled recycling | 100.1 | 38.50% |
| | plastic mixture | | |
| extruder 5 | pure, i.e. virgin | 65 | 25.00% |
| | base polymer | | |
| | colourant | 5.2 | 2.00% |
| | | 260 | 100.00% |

The respective barrier layer laminate obtained from the execution examples 1-7 can be homogenised after the first use of the barrier layer laminate for containers or other products and mixed with “virgin” base polymer, for example HDPE, or extruded in parallel with this, in order to produce one-, two- or three-layer containers which preferably have a capacity in the range from 0.5 l to 50 l, preferably 1 l to 20 l, and are themselves self-supporting, i.e. dimensionally stable, and optionally stackable.

These one-, two- or three-layer containers produced in this way can in turn be used, essentially without material loss, in a closed-loop process to produce further one-, two- or three-layer containers.

For the production of a container from such a mixed barrier layer laminate and “virgin” polyolefin, in particular HDPE, the preform, as also already described above, from the preceding process is placed in a non-melted state into a steel/aluminium mould which is cooled with cold water at temperatures between 8 °C and 15 °C, in order to shape the preform with a predetermined design and to cool the preform, whereby the formed container transitions from a pasty state to a solid state. The shaping takes place by an injection of compressed air at a pressure in the range from 7 to 10 bar into the preform for a specific time, so that the product produced undergoes the correct shaping and solidification and thus takes on the shape of the mould.

It should be noted here that all parts described above, both individually and in any combination, in particular the details shown in the drawings are claimed as essential to the invention. Modifications to this are familiar to those skilled in the art.

1. Method for producing a barrier layer laminate, in particular for producing containers, comprising:
providing an extrudable barrier layer material;
providing a polyolefin;
providing particles of layered plastic material which is obtained by a comminution of existing or recycled extrudable layer laminate with barrier layer;
mixing a portion of the polyolefin with the particles to produce a recycling plastic mixture;
feeding the barrier layer material, the polyolefin and the recycling plastic mixture to a respective extruder; and
performing a coextrusion of barrier layer material, polyolefin and recycling plastic mixture to produce a barrier layer laminate having the following layer sequence:
1) first outermost layer, namely a barrier outer layer;
2) embedded layer, namely layer of recycling plastic mixture;
3) a second outermost layer arranged opposite the first outermost layer, namely a polyolefin outer layer.

2. Method according to claim 1,
wherein
in the course of the coextrusion, an adhesion-promoting layer is extruded between the barrier outer layer and the layer of recycling plastic mixture in order to produce a 4-layer barrier laminate.

3. Method according to claim 2,
wherein
in the course of the coextrusion, a further layer of polyolefin, namely a polyolefin intermediate layer, is extruded between the adhesion promoter layer and the layer of recycling plastic mixture, in order to produce a 5-layer barrier laminate.

4. Method according to claim 1,
wherein
the recycling plastic mixture has a particle content in the range from 30 wt. % to 95 wt. %.

5. Method according to claim 2,
wherein
the polyolefin outer layer contains an additive and/or a colourant in the following proportions by weight:

| | 4-layer barrier laminate | 5-layer barrier laminate |
|---|---|---|
| additive | 11.2 ± 5 wt. %, | — |
| | [symbol] | |
| | [symbol] | |
| | [symbol] | |
| colourant | 10.0 ± 0.5 wt. %, | 7.4 ± 0.5 wt. %, |
| | [symbol] | [symbol] |
| | [symbol] | [symbol] |
| | [symbol] | [symbol] |

or only the additive and no added colourant.

6. Method according to claim 2,
wherein
the polyolefin intermediate layer comprises an additive and/or a colourant in the following proportions by weight: 8.6±5 wt. % or only the additive and no added colourant.

7. Method according to claim 2,
wherein the barrier layer laminate consists of layers with the following weight proportions:

| layer | 4-layer barrier laminate | 5-layer barrier laminate |
|---|---|---|
| barrier outer layer | 12 ± 6 wt. %, [symbol] | 12 ± 6 wt. % [symbol] |
| | [symbol] | [symbol] |
| | [symbol] | [symbol] |
| adhesion-promoting layer | 12 ± 6 wt. %, [symbol] | 12 ± 6 wt. % [symbol] |
| | [symbol] | [symbol] |
| | [symbol] | [symbol] |
| polyolefin intermediate | — | 50 ± 20 wt. % [symbol] |
| layer | | [symbol] |
| | | [symbol] |
| layer of recycling plastic | 69.5 ± 40 wt. % [symbol] | 69.5 ± 40 wt. % [symbol] |
| mixture | [symbol] | [symbol] |
| | [symbol] | [symbol] |
| | [symbol] | [symbol] |
| polyolefin outer layer | 40 ± 30 wt. % [symbol] | 40 ± 30 wt. % [symbol] |
| | [symbol] | [symbol] |
| | [symbol] | [symbol] |

8. Barrier layer laminate, produced by a method according to claim 1.

9. Container made from a barrier layer material according to claim 8.

10. Container according to claim 9,
wherein
the container is made with a proportion from 45 to 80 wt. % of a recycled and homogenised barrier layer material or from a recycled and homogenised barrier layer material and a proportion of a virgin high-density polyethylene that completes that proportion of recycled and homogenised barrier layer material up to 100 wt. %.

11. Container, according to claim 9,
wherein
the container is a one-layer container, wherein the recycled and homogenised barrier layer material and the virgin HDPE are homogeneously mixed with one another;
or
the container is a two-layer container, wherein the recycled and homogenised barrier layer material and the virgin HDPE are arranged flatly adhering with each other next to one another;
or
the container is a three-layer container, wherein the recycled and homogenised barrier layer material is arranged between the virgin HDPE flatly adhering with each other on both sides.

12. Container, according to claim 9,
wherein
the container is a rigid container, and optionally is a stackable container.

13. Method for producing a container according to claim 9, comprising:
providing a barrier layer laminate;
comminuting the barrier layer laminate or the container to produce particles;
providing a polyolefin;
feeding the comminuted barrier layer laminate and the polyolefin into a common extruder in order to homogeneously mix the particles of the barrier layer laminate and the polyolefin and to extrude them together through a single extruder nozzle into a preform of the container, in order to produce a one-layer container;
or
feeding the comminuted barrier layer laminate and the polyolefin into two extruders in order to extrude the particles and the polyolefin in parallel with each other through two extruder nozzles into a preform of the container, in order to produce a two-layer container;
or
feeding the comminuted barrier layer laminate and the polyolefin into three extruders in order to extrude the particles of the barrier layer laminate and the polyolefin in parallel with each other through three extruder nozzles into a preform of the container, in order to produce a three-layer container, wherein the polyolefin is fed into the two respective outer extruders; and
inflating the respective preform produced.

14. Method for producing a one-layer container according to claim 10, comprising:
providing material of at least one container;
comminuting the material of at least one container in order to produce particles of the material;
feeding the comminuted material of at least one container into an extruder in order to homogeneously mix the particles of the comminuted material and to extrude them together through an extruder nozzle into a preform of the container in order to produce a one-layer container;
inflating the preform produced.

15. Method according to claim 13,
the proportion of additive in the recycling material to be extruded is optionally adjusted to a proportion in the range from 0.9 wt. % to 2.0 wt. % prior to the extrusion.

16. Method according to claim 1, wherein the barrier layer material is polyamide or ethylene vinyl alcohol copolymer (EVOH).

17. Method according to claim 1, wherein the polyolefin is a polyethylene having a density in the range from 0.94 g/cm3 to 0.97 g/cm3.

18. Method according to claim 1, wherein the polyethylene has a density in the range from 0.95 g/cm3 to 0.97 g/cm3.

19. Method according to claim 1, wherein the polyethylene has a density in the range from 0.951 g/cm3 to 0.961 g/cm3.

20. Method according to claim 1, wherein the polyolefin is a high-density polyethylene (HDPE).
